(19) United States
(12) Patent Application Publication
(10) Pub. No.: US 2012/0248183 A1
(43) Pub. Date: Oct. 4, 2012

(54) Vending Machine For Rental Services

(76) Inventor: James Allen Cook, Lebanon, MO (US)

(21) Appl. No.: 13/077,089

(22) Filed: Mar. 31, 2011

(51) Int. Cl. G06Q 20/00; G06Q 30/00

(52) U.S. Cl. 235/381

(57) ABSTRACT

System for renting a cellphone, ipad or other electronic device for temporary use. Plurality of cellphones, ipads or other electronic devices are categorized and barcoded. A vending machine that receives a credit card information and request to rent one of the cellphones/ipads or other electronic devices from a user, releases the cellphone/ipad or other electronic device to a bar code reader which send the barcode information to a central processing unit that creates a user account and associates it with the credit card information and initiates timer. The timer is stopped when the same barcode is received by the processing unit and the user account is retrieved, then the credit card is charged with a calculated usage by the central processing unit. A rented cellphone, ipad or other electronic device may be authorized to access a remote central server for multimedia content.

### DESCRIPTION OF RELATED ART

The present application relates to a vending machine, and more particularly to vending machine for renting a cellphone, ipad or other electronic device for temporary use.

Note that the points discussed below may reflect the hindsight gained from the disclosed inventions, and are not necessarily admitted to be prior art.

Automated vending machines have been widely installed to provide services and conveniences 24/7. In addition to selling variety of articles for purchase, automated vending machines have been developed for renting services. For example, US 2009/0119216 A1 discloses an automatic vending machine for renting multimedia files which is temporarily transferred to a portable device of a user.

U.S. Pat. No. 4,995,498 discloses a vending machine for renting DVDs and movie cassettes that uses bar codes to track the rented cassettes, and the cassettes are returned via mail. U.S. Pat. No. 4,951,308 describes a vending machine that rents out cellphones using telephone number to monitor the phone usage and charges the user according to the usage.

This application provides an alternative and a simpler way for renting a cellphone, or other electronic devices.

### SUMMARY

The present application discloses new approaches to an automatic vending machine that rents cellphones, ipads or other electronic devices using a bar code identification system, and allows users to buy insurance and return rented devices back to the vending machine.

In one embodiment, the vending machine has plurality of storage compartments where bar coded cellphones, ipads or other electronic devices are categorized and stored separately.

In one aspect of an embodiment, a two way conveyor belt transports a selected cellphone, ipad or other electronic device from its storage compartment to a bar code reader exit, and in reverse direction the belt carries a returned cellphone, ipad or other electronic device from the bar code reader entrance back to the categorized storage compartment.

In one aspect, a computer controlling unit creates a user account using the cellphone, ipad or other electronic device barcode that is being rented, and associates the user's credit card number with this account. A timer starts counting time when the user account is created.

In one aspect, a user display screen on the vending machine displays all the categorized cellphones, ipads, or other electronic devices according to the entertainment content that are stored in each of the cellphones, ipads or other electronic devicess.

In one aspect, insurance is purchased for a rental unit and the cost is charged directly to the associated credit card.

In another embodiment, the vending machine is connected to a central server via the internet, the status of the vending machine automatically is updated each time there is a transaction. The barcode of a rented cellphone, ipad or other electronic device is transmitted to a central server, and the rented cellphone, ipad or other electronic device is automatically connected to internet service and other game and entertainment services, categorized media content becomes available for downloading to the rented cellphone, ipad or other electronic device.

The disclosed innovation, in various embodiments, provides a simple and easy convenience for busy people who travel and stop around international airports, bus stations, and high way gas stations.

### BRIEF DESCRIPTION OF THE DRAWINGS

The application will be described with reference to the accompanying drawings, which show important sample embodiments of the invention and which are incorporated in the specification hereof by reference, wherein:

FIG. 1 schematically shows an example vending machine for renting a cellphone, ipad or other electronic device in accordance with this application.

FIG. 2 shows a flow chart of an example command chain of a vending machine for renting a cellphone, ipad or other electronic device in accordance with this application.

FIG. 3 shows a flow chart of an example command chain of a vending machine for returning a cellphone, ipad or other electronic device in accordance with this application.

FIG. 4 shows a flow chart of an example command chain of loading multimedia to a rented cellphone, ipad or other electronic device in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the disclosed invention apply to other personal electronic devices; for clarity reason, the examples are given based on a cellphone, ipad or other electronic device, but an ordinary person in the art would know the variations to modify the design to make a necessary changes to accommodate other electronic devices.

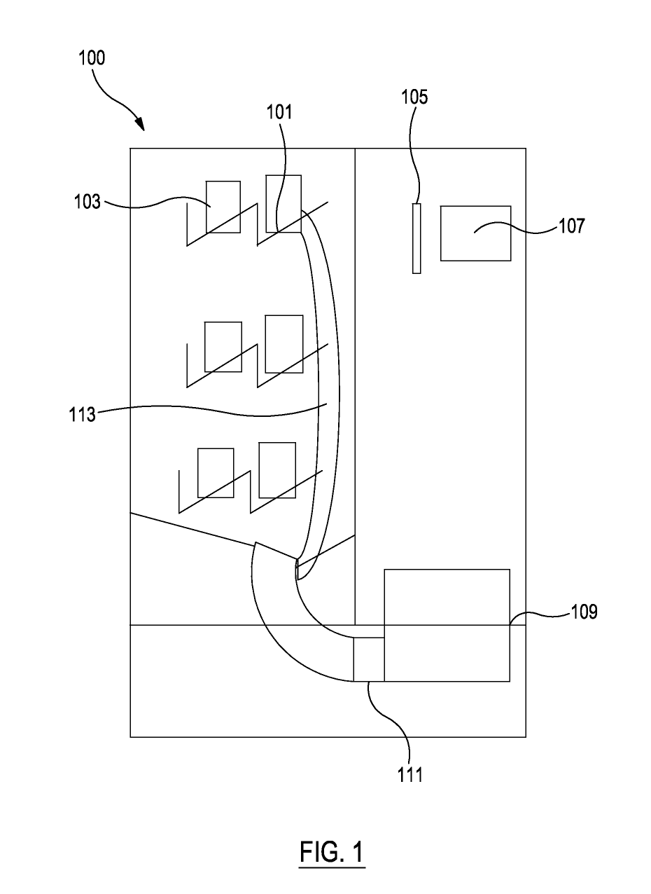

In reference to FIG. 1, vending machine 100 for renting a cellphone, ipad or other electronic device includes categorized storage and display racks 103 and 101 that store cellphones, ipads or other electronic devices according to a preset category. Each of the cellphones, ipads or other electronic devices is bar coded for identification and status tracking. Two way conveyor belt 113 transports a selected cellphone, ipad or other electronic device from its storage compartment to bar code reader exit 111, and in reverse direction the belt carries a returned cellphone, ipad or other electronic device from the bar code reader entrance 109 back to the categorized storage compartment 101 or 103. Conveyor 113 may be controlled by multiple step motors which are electronically connected with a central processing unit (CPU). Bar code reader exit and entrance is disposed with a bar code reader that is also electronically connected with the computer system of the vending machine. The vending machine also includes a user screen 107 and a credit card reader 105. User screen 107 displays the categories of cellphones, ipads or other electronic devices for selection and renting, and also for credit card instruction and usage display. The categories of cellphones, ipads or other electronic devices may be based on the pre-installed games or multimedia content. User screen 107 may be a touch screen in combination with a keypad.

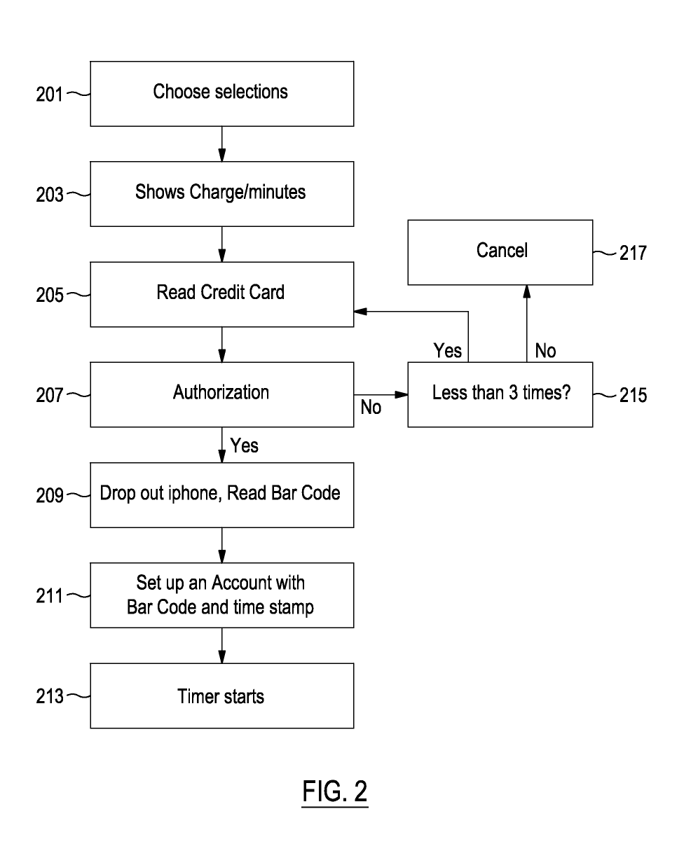

A central processing unit is built in the vending machine and is electronically connected with each of the operating parts. In reference to FIG. 2, the computer system in the vending machine operates to perform multistep functions. A user who wants to rent a cellphone, ipad or other electronic device may touch the screen 107 to enter into selections at step 201. Screen 107 sends the selection to the central processing unit which retrieves the categories of content and selections with price information from a database for display at step 203.

Included with the price information is a statement that if the device is not turned in within a preset time, then the credit card will be billed for the cost of the device along with the time that it was signed out for, or if there is damage to the device then you will be billed. Also included with the price information is an explanation that you will be able to purchase charged, headphones and other accessories.

Also included with the price statement is information about a program that will be installed on all the devices to prevent the download or upload of files to or from the device to prevent theft of music, movies or other media.

After the user selects which cellphone/ipad or other electronic device to rent, he/she is prompted to swipe a credit card at step 205, then the system goes through the authorization process in 207, and this process may be repeated three times at step 215 if the authorization fails. If authorization fails for the 4^{th} time, the system cancels the renting process at step 217, and return back to the first screen. After the successful authorization step 207, the central processing unit sends signal to the selected storage compartment 101/103 to release a cellphone/ipad or other electronic device to conveyor belt 113, and signal to the step motors which moves to the belt to carry the cellphone/ipad or other electronic device to the exit for bar code reading by bar code reader 111 at step 209. The read bar code information is then sent back to the central processing unit which at step 211 sets up an user account using the bar code as identifier and associates the user's credit card information with this account. At the same time, the central processing unit initiates a timer to be associated with this user account.

The vending machine's computer system may be connected to the internet via either wireless communication or cable. The whole transaction may be counted as one transaction and the status of it may be send to a remote central server via the internet for remote management.

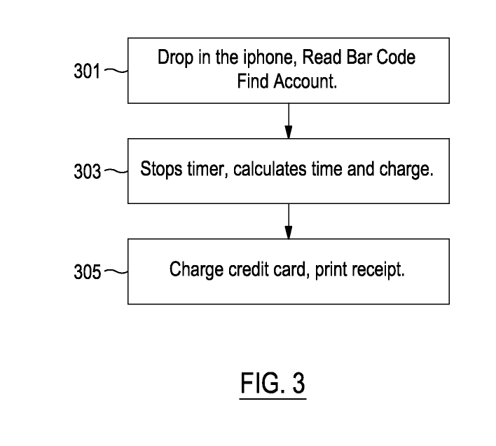

In reference to FIG. 3, after use, the user should return the cellphone/ipad or other electronic device back to the vending machine. When the user drops the cellphone/ipad or other electronic device into receiver entrance 109, the cellphone/ipad or other electronic device slides to the bar code reader 111 which reads the bar code of the returned device and sends it to the central processing unit at step 301. The central processing unit then retrieves the user account using the bar code as identifier and stops the timer, calculates the usage time and charge at step 303. At step 305, the associated credit card is then charged with the amount and a receipt is printed for the user to keep as a record. The returned cellphone, ipad or other electronic device is carried back to its storage compartment according to its category.

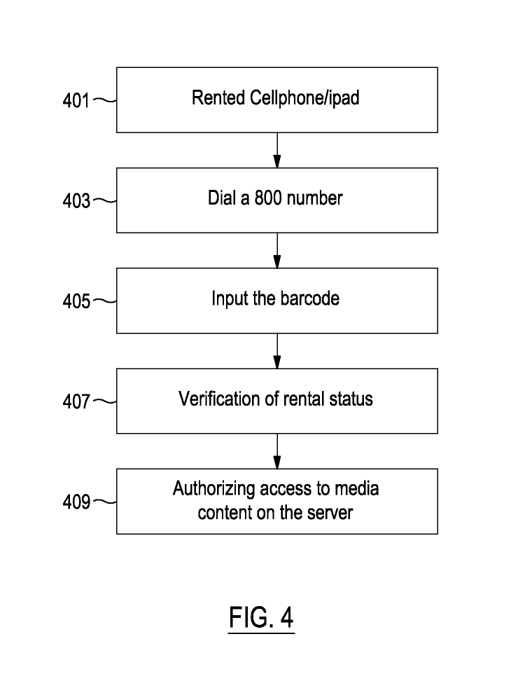

In reference to FIG. 4, a user may rent the cellphone, ipad or other electronic device for multimedia content or games pre-installed on the device, or they may use the device to connect to a central server to more choices. After renting step of 401, a 1-800 number is provided with the phone for the user to call into at step 403, once the user inputs the bar code of the cellphone, ipad or other electronic device at step 405, the central server verifies the rental status at step 407 with the vending machine or with its own database if the vending machine constantly updates its renting transactions with the central server. At 409 the central server authorizes the level of internet access, the cellphone, ipad or other electronic device may be accessed to a multimedia download web page for more content download.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: U.S. Pat. No. 4,951,308, U.S. Pat. No. 4,995,498 and US patent application US 2009/0119216 A1.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A vending machine for renting multimedia electronic devices, comprising:
a plurality of bar coded electronic devices which are stored according to their categories;
a barcode reader;
a credit card reader;
a user display;
a two way conveyor system; and
a computer system;
wherein said computer system is electronically connected with each functional component, and after receiving a barcode reading from said barcode reader reading of one of said electronic devices, creates a user account using said barcode as identifier, associates a credit card information sent by said credit card reader with the barcode and initiates a timer.

2. The vending machine of claim 1, wherein said computer system searches for a user account using said barcode, and once retrieving said user account, stops said timer, calculates a usage and monetary charge amount, charges said monetary amount to said credit card.

3. The vending machine of claim 1, wherein electronic devices are categorized according to their pre-installed multimedia content.

4. The vending machine of claim 1, wherein at least one of said electronic devices is a cellphone.

5. The vending machine of claim 1, wherein at least one of said electronic devices is an ipad or other electronic device

6. The vending machine of claim 1, wherein said computer system is electronically connected to a central server system via the internet.

7. The vending machine of claim 1, wherein a rented electronic device is allowed to access a central server system for multimedia content.
